(19) United States
(12) Patent Application Publication
(10) Pub. No.: US 2018/0163818 A1
(43) Pub. Date: Jun. 14, 2018

(54) Multiple Torque Source Drivetrain System

(71) Applicant: Hunter Robert Normandeau, Portsmouth, NH (US)

(72) Inventor: Hunter Robert Normandeau, Portsmouth, NH (US)

(21) Appl. No.: 15/373,988

(22) Filed: Dec. 9, 2016

(51) Int. Cl. F16H 1/22

(52) U.S. Cl. CPC F16H 1/227; F16D 41/069

(57) ABSTRACT

An apparatus of drivetrain power transmission comprising multiple independently controlled torque sources, utilizing an input mechanism configured to receive an input to control the torque sources, a gear train mechanically linking the torque sources with a clutching mechanism the torque sources, operated via a computerized controller configured to actuate the torque sources to achieve desired power characteristics is disclosed herein. Corresponding systems and methods also are disclosed.

### BACKGROUND

This disclosure relates generally to drivetrain architecture, and more particularly to synchronizing multiple torque sources with one another.

Conventional multi-ratio transmissions that utilize the power from a single input are generally known. Conventional multi-ratio transmissions have features including the ability to either step down or up the output speed of a shaft in relation to an input. However, most conventional multi-ratio transmissions are very complicated in their mechanical design, requiring a large number of components. Additionally, they tend to take away a non-trivial amount of power with them in the form of parasitic frictional losses.

It would be useful to develop/improve the cost and efficiency of drivetrain systems.

### SUMMARY

One embodiment described herein is a drivetrain power transmission device comprising multiple independently controlled torque sources, an input mechanism configured to receive an input to control the torque sources, a gear train mechanically linking the torque sources with a clutching mechanism configured to couple and decouple the torque sources, operated via a computerized controller configured to actuate the torque sources to achieve desired power characteristics.

Another embodiment is a method comprising obtaining a drivetrain power transmission device comprising first and second independently controlled torque sources, an input mechanism configured to receive an input to control the first and second torque sources, a gear train mechanically linking the first and second torque sources, a clutching mechanism configured to couple and decouple the first and second torque sources, and a computerized controller configured to actuate the first and second torque sources to achieve desired power characteristics operating a moving vehicle, tool, or robot using the drivetrain power transmission device.

Another embodiment described herein is a hardware configuration of the system in which the torque sources are coplanar.

Yet another embodiment described herein is a hardware configuration of the system in which the torque sources are axial.

### BRIEF DESCRIPTION OF THE DRAWINGS

FIG. 1 illustrates an isometric view of a four torque source assembly according to a first embodiment.

FIG. 2 shows an exploded view of the first embodiment of the assembly to better display individual mechanical components.

FIG. 3A shows an end view of the first embodiment.

FIG. 3B depicts a cross section of the four torque source embodiment taken along line A-A of FIG. 3A.

FIG. 4 illustrates the first embodiment with the front plate removed to expose the strategically staggered ratios of each torque source.

FIG. 5 is an isometric view of a three torque source variant of the assembly depicted in FIG. 1.

FIG. 6 depicts an example control-loop of behavioral output from a four electric motor torque source configuration.

FIG. 7 shows an alternative hardware configuration of axial alignment of two torque sources.

FIG. 8 is a graph showing a computer simulation of system performance as measure in newton meters (NM) of torque from the final output comparing the plural torque source technology with a conventional direct drive solution.

FIG. 9 is a graph showing a computer simulation of system performance as measured in power output (KW) from the final output comparing the plural torque source technology with a conventional direct drive solution.

### DETAILED DESCRIPTION

The embodiments described herein provide for a new way of configuring and controlling multiple sources of torque in a pseudo-parallelized/serialized fashion with an array of drives spanning a wide ratio that overlap each other. When used for transient applications, the device will run setups that require a torque range that a single non-ratio shifting source cannot handle alone. With this new physical integration, a brand new control method is required for powering each individual motor. As a non-limiting example power distribution using this technology in the context of an automobile with a traditional gear box; the car is 50% in first gear, 30% in second gear, and 20% in third gear all at once. The automobile is in any number of gears simultaneously with the ability to power the most suitable torque sources in a given situation.

As used herein, the term “torque source” means any sort of motive device capable of exerting power rotationally. A “sprag clutch” is akin to a traditional ball bearing except that instead of rolling balls, there are sliding oblong “sprags” that allow rotation in one direction but lock the bearing when backdriven.

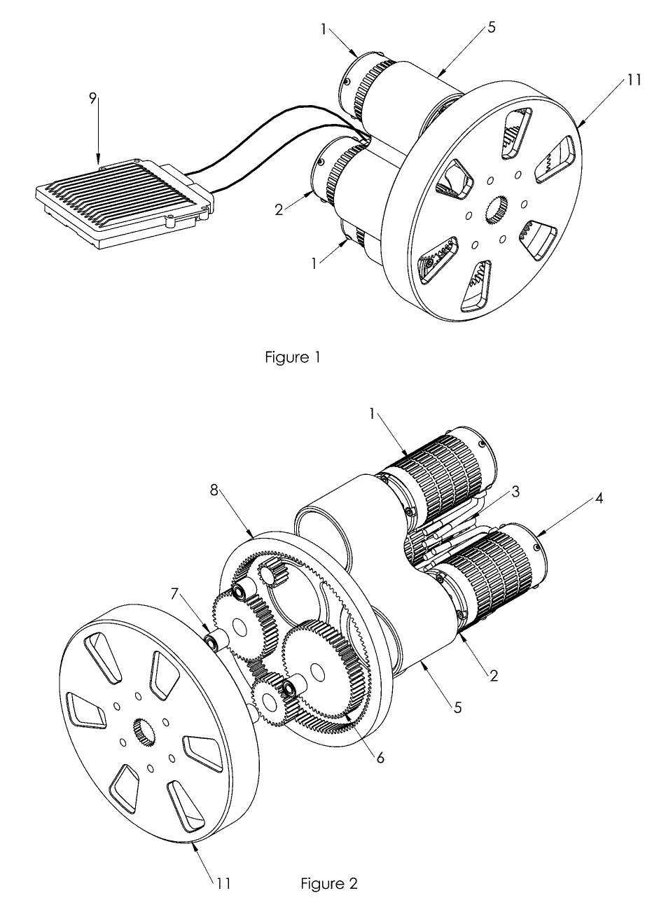

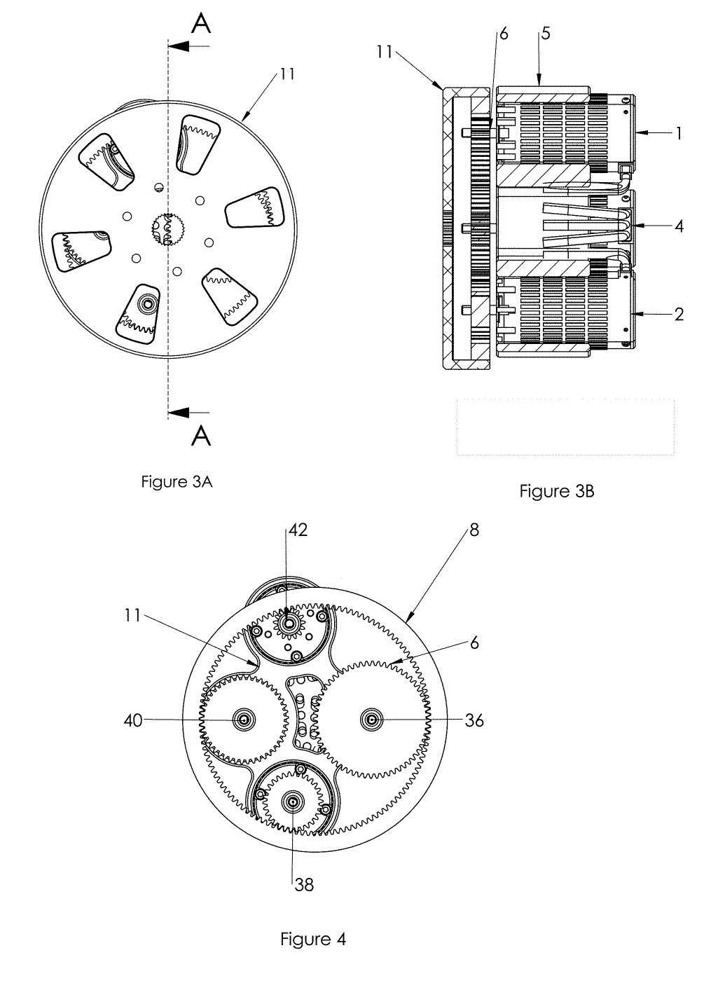

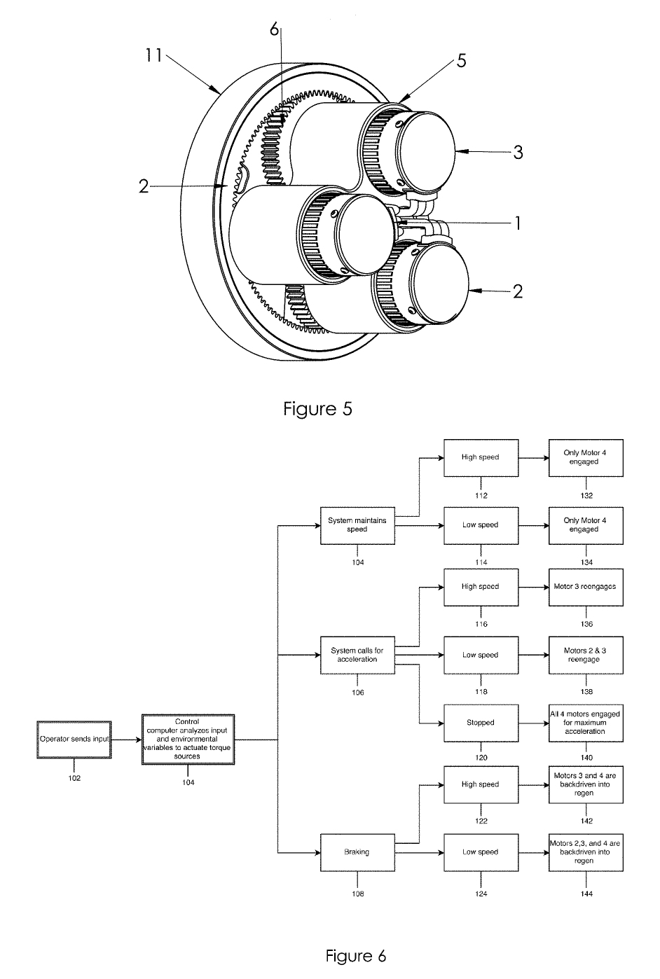

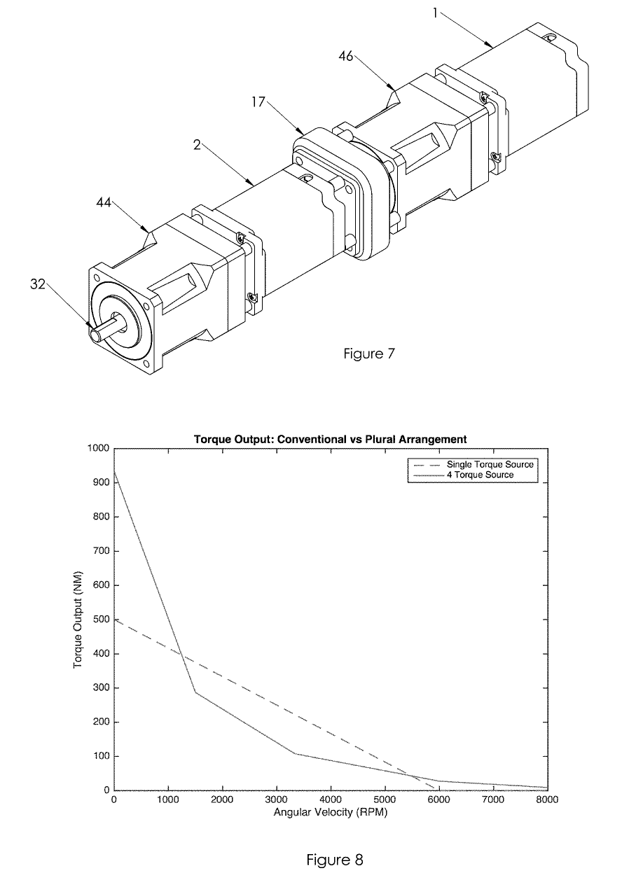

Referring to the drawings, to stretch the useful power band of drivetrains, a main drive unit as displayed in configurations including FIG. 1, FIG. 5 and FIG. 7 is comprised of multiple torque sources linked together. The overall main drive unit is designated as (2). FIG. 2 shows an exploded view of the assembly of FIG. 1 to better describe the internal components. FIG. 1 includes a physical representation of the control computer (9). Four electric motors (1), (2), (3) and (4), which are the torque sources in the embodiment shown are contained by a motor carrier (5) and are each attached to spur gears (6), though use of helical, herringbone or other gear meshing geometries may be used, through sprag clutches (7). The driven outer ring gear (8) is connected to the output torque plate (11) where a shaft (32) or other output coupling may be attached. Each torque source has a different ratio (36), (38), (40), (42), in relation to the final output arranged sequentially such that as the torque of one unit starts to taper off, another one is behind it ready to deliver power at higher final output angular velocity.

The clutching mechanism can either be an active coupling (17), shown in FIG. 7, that can be either engaged or disengaged via an electronic command from the control computer (9) or a simple mechanical diode such as a sprag clutch bearing (7). The advantage of a sprag clutch is reduced mechanical complexity but this component has one downside in some cases. The disadvantages of using a sprag clutch for torque source disengagement is the inability for each motor to be backdriven. All embodiments shown use electric motors (1), (2), (3), (4) as their motive power. Many electric motors can be backdriven to work as generators and recuperate momentum back into usable energy. While the illustrated embodiments use electric motors as their motive power, the assembly can also be used with other types of torque sources, including but not limited to turbines, reciprocating mass combustion engines, flywheels, and hydraulic/pneumatic fluid motors.

Efficiency is one of the most important considerations in an electric drivetrain and regenerative braking would not be supported on motor torque sources that rely on mechanical diodes. With an active coupling (17), there is a freedom to apply regenerative characteristics. For every control configuration relating to thrust, an equivalent set of regenerative characteristics is also true. FIG. 6 describes some non-limiting cases of regenerative braking.

A clutching mechanism integrated with individual motors (7), (17), can improve highway speed efficiency as unneeded motors can disengage, resulting in reduced drivetrain loss. FIG. 5 shows a three torque source variant of the assembly depicted in FIG. 1. Along with different ratio spreads, specific applications will require greater or fewer motors to accomplish their requirement.

FIG. 6 is a flow chart, generally designated as (100) showing a method of operation through an example control scheme of behavioral output from a four-electric motor configuration based upon user inputs and environmental situations in an automotive application. Non-limiting examples of input sources from an operator (102) include the actuation of an accelerator pedal, brake pedal, steering wheel, and mode selector. Non-limiting examples of an operator include an individual locally piloting an automobile, an individual sending inputs electronically from a remote location, and an autonomous computer vision controller. Non-limiting examples of Environmental variables include the current speed of the vehicle, the angle of road the car is traveling on, and the surface conditions of said road. The logic of (100) is continuously looping to reassess the current situation and make needed changes according to new inputs and environmental conditions in real time (104). Each motor is controlled individually in such a way that there is a smooth transition from one end of the ratio spectrum to the other via a central computer (9). Should the control scheme decide through user inputs (102) and environmental data, that the vehicle maintain speed (104), whether the vehicle is traveling “high speed” (112) or “low speed” (114), then motor four in embodiments has enough torque to maintain the vehicle speed alone. If the control scheme determines that the operator requests acceleration (106), it will react differently based upon the situation. If the vehicle is still traveling at “high speed” (112), then only motor three and four are able to contribute as motors one and two, if reengaged, would be outside their usable angular velocity range. At “low speed” (118), it is useful to reengage motor two as well. Finally, from a complete stop (120), all motors are available to assist in acceleration (140). If during the operation of embodiments, the user gives an input by depressing the brake pedal (108), the control scheme will attempt to recuperate some of the vehicle kinetic energy by backdriving the motors. Which motors are available for this function depends on vehicle speed. At “high speed” (122), only motors three and four can be backdriven (142) since motors one and two would exceed their maximum safe angular velocity if engaged. At “low speed” (142), motor two is also available to assist in regen (144).

In a scenario where a vehicle accelerates continuously from a stop (120), all four motors begin engaged (140) with max torque applied to all of them. As speed and therefore angular shaft (32) velocity increases, motor one (smallest gear) disengages from the drivetrain and freewheel. As speed increases even further and motor two is no-longer at an efficient/reliable angular velocity, it too disengages. Once the vehicle reaches cruising speed and no longer needs the power deliverable from multiple motors, motor three will also disengage, leaving motor four to sustain constant speed (132).

FIG. 7 shows an alternative hardware configuration of axial alignment of two torque sources wherein the first (1) is an intermittent source with a low ratio (46) that is engaged for low speed, high torque events and the second (2) is a permanently engaged high ratio (44) source. FIG. 7 also shows the use of an active coupling. Both axial and coplanar configurations can use either passive couplings (7) or active couplings (17).

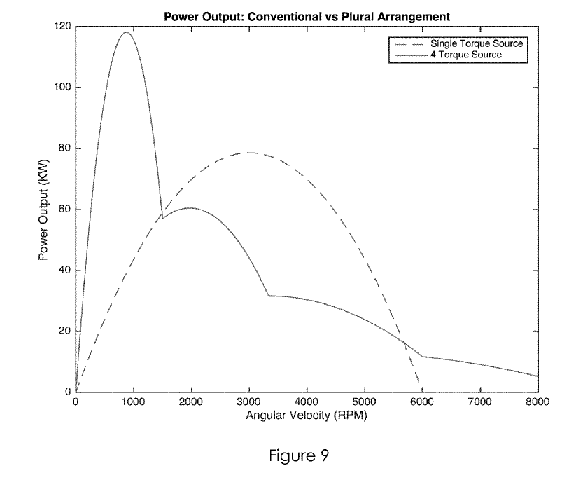

FIG. 4 illustrates a potential configuration wherein each there are 4 torque sources (36), (38), (40), and (42) in staggered reduction ratios. A non-limiting example of suitable reduction ratios is 2:1 (36), 4:1 (38), 8:3 (40), and 8:1 (42). Exact ratio selection is dependent on individual use-case but in general a wider spread of ratios will allow the system to pull heavier loads and coast more efficiently while compromising performance in-between extremes as maximum power will limit by the output of a single torque source. With ratios spread further apart, the next motor will not yet be useful to aid final output. In some embodiments, the ratio from top to final reductions can range from two to one-hundred. The separation of local maximas (50) as shown in FIG. 9 will grow more isolated from other torque source's influences. One distinction between co-axial configurations as seen in FIG. 7 and co-planar configurations as seen in FIG. 1 is that co-axial solutions must operate in a strict sequential manner. With lower reductions toward the back of the unit (in respect to the output), once a torque source is decoupled, any torque sources behind it are also decoupled. This, however should not present a significant problem since most applications will only require motors to be decoupled and reengaged in that order.

FIG. 8 and FIG. 9 show computer simulations of system performance as measured in newton meters (NM) of torque (FIG. 8) and power output (KW) (FIG. 9) from the final output shaft (32), comparing the plural torque source technology with a conventional direct drive solution. In this comparison, a permanent magnet electric motor of a specific peak torque output (500 NM) is direct driven. The plural torque source solution uses four separate motors, each with one-fourth of the single motor's peak torque (125 NM). Both the large and small motors have an identical specific maximum angular velocity of 6000 RPM. While the motors of the multiple torque source design in this scenario have identical characteristics, torque sources of different characteristics can be strategically combined to optimize for a particular use-case. At both the high and low extremes of the angular velocity range, the multi-torque source device outperforms the control motor and can reach into ranges otherwise unobtainable. At 6000 RPM, the control motor has no torque output and is unable to provide any more power whereas the multi-source system is able to continuing supplying power far above the control motor's redline. The system is especially beneficial at low speed operations where the multi-torque source device is able to provide nearly twice the starting torque as a control motor.

In embodiments, the drivetrain power transmission device includes two or more independently controlled torque sources. In embodiments, the device includes two to ten independently controlled torque sources, or two to six independently controlled torque sources, or three to seven independently controlled torques.

Along with varying torque source specifications, the torque accumulator can be comprised of differing sized components and materials for requirements spanning handheld to heavy industry and trucking applications. Non-limiting examples of uses for the technology include being the motive power element in a forty-ton bulldozer that encompasses an entire engine room using cast iron components, and an application where the device is the power mechanism for a surgical tool that requires a large range of angular velocities with high stalling torque using small injection molded thermoplastic components.

A number of alternatives, modifications, variations, or improvements therein may be subsequently made by those skilled in the art, which are also intended to be encompassed by the following claims.

What is claimed is:

1. A drivetrain power transmission device, comprising:
a. first and second independently controlled torque sources,
b. an input mechanism configured to receive an input to control the first and second torque sources,
c. a gear train mechanically linking the first and second torque sources,
d. a clutching mechanism configured to couple and decouple the first and second torque sources, and
e. a computerized controller configured to actuate the first and second torque sources to achieve desired power characteristics.

2. A device according to claim 1, wherein the gear train includes an output gear for each torque source, and the first and second torque sources are co-planar with staggered ratios such that the output gear of each torque source contacts a single ring gear attached directly to the system's final output.

3. A device according to claim 1, wherein the first and second torque sources are co-axial, and the gear train includes a reduction gear and a clutching mechanism between the torque sources.

4. A device according to claim 1, wherein each torque source has identical power delivery characteristics.

5. A device according to claim 1, wherein each torque source has different power delivery characteristics than the other torque sources.

6. A device according to claim 1, wherein instructions are given to the device via at least one operator.

7. A device according to claim 1, wherein the clutching mechanism is passive, entailing the use of a sprag clutch mechanical diode.

8. A device according to claim 1, wherein the clutching mechanism is active, requiring intentional actuation of an interlocking torque transmission coupling via a control scheme.

9. A device according to claim 1, wherein the clutching mechanism is active, requiring intentional actuation of a frictionally based torque transmission component via a control scheme.

10. A device according to claim 1, wherein angular velocity sensors are placed on the plurality of individual torque sources.

11. A device according to claim 1, wherein each torque source has a separate circuit for powering and modulating each torque source that executes real-time instructions from the computerized controller.

12. A device according to claim 1, wherein each torque source outputs an individually exerted load to inform the computerized controller of system energy consumption and power distribution in real-time.

13. A device according to claim 1, where in the gear train is at least partially submerged in an oil bath in a fluid-proof enclosure.

14. A device according to claim 1, where in the gear train runs in direct contact with the atmosphere.

15. A device according to claim 1, where in the gear train is comprised of cast or machined metal components.

16. A device according to claim 1, where in the gear train is comprised of injection molded thermoplastic components.

17. A device according according to claim 1, further comprising a third independently controlled torque source.

18. A device according according to claim 17, further comprising a fourth independently controlled torque source.

19. A method of operating a moving vehicle, tool, or robot using the device of claim 1.

20. A method comprising:
obtaining a drivetrain power transmission device comprising first and second independently controlled torque sources, an input mechanism configured to receive an input to control the first and second torque sources, a gear train mechanically linking the first and second torque sources, a clutching mechanism configured to couple and decouple the first and second torque sources, and a computerized controller configured to actuate the first and second torque sources to achieve desired power characteristics operating a moving vehicle, tool, or robot using the drivetrain power transmission device.
